(19) United States
(12) Patent Application Publication
(10) Pub. No.: US 2010/0032943 A1
(43) Pub. Date: Feb. 11, 2010

(54) QUICK INSTALLED JOINT ASSEMBLY

(75) Inventors: Chun-Hung LI, Taichung (TW); Wei-Mien Hsu, Taichung (TW); Yongjun Wu, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Globe Union Industrial Corp, Taichung Export Processing Zone (TW)

(21) Appl. No.: 12/188,589

(22) Filed: Aug. 8, 2008

(51) Int. Cl. F16L 41/00

(52) U.S. Cl. 285/122.1

(57) ABSTRACT

A quick installed joint assembly includes a fitting body, a sleeve, and an inlet pipe. One end of the chamber of the body communicates with a water supply pipeline, and the other end communicates with an accommodation part and passing through the fitting body. The sleeve is disposed within the accommodation part and has stopper portions. Each stopper portion has a wedge-like portion and a hook portion is extending outwardly from the wedge-like portion. The body has plural openings corresponding to each stopper portion, so that one end of the inlet pipe can pass through the sleeve and be inserted within the chamber. The inlet pipe corresponding to the bottom edge of the stopper portion has a large diameter portion for leaning against on the stopper portion, so the hook portion can be hooked on the openings and the inside wall of the accommodation part can support the wedge-like portion.

### BACKGROUND OF THE INVENTION

1. Field of Invention

The present invention relates to a joint assembly for the water supply pipeline, and more particularly to a quick installed joint assembly suitable for being quickly assembled and capable of ensuring the pipe linkage effect.

2. Related Art

The faucet used in most families usually sets up on the surface of washbasin and connects to the water supply pipeline by a bendable connecting pipe under the washbasin. In generally, such connecting pipe has screw locks disposed in both ends, in which a leakage protective cushion is disposed over each of the screw locks. Besides, the screw lock in the one end is screwed to the thread portion of the water supply pipeline. The faucet fastened to the washbasin has a screw thread pipe screw-connected to the bottom of faucet body. The screw lock in the other end of the connecting pipe is screwed to the outer thread portion of the screw thread pipe, so as to form a water supply pipeline. Such structure has been disclosed in the U.S. Pat. No. 6,381,776 and No. 6,256,810.

The washbasin is usually mounted to the wall, and the faucet is practically set on the side of the washbasin close to the wall, so that the space underneath the faucet is very narrow and small. Therefore, it is inconvenient to operate the connection between the screw lock of the connecting pipe with the outer thread portion of the screw thread pipe in such narrow and small space, and this is a quite time-consuming and bothersome work. Therefore, it is necessary to design a new structure capable of being quickly and conveniently assembled in order to overcome the above-mentioned problems.

The pipeline structure capable of being quickly and conveniently assembled has been disclosed in the field of electrical pipeline, such as U.S. Pat. No. 4,836,580 and No. 4,989,905 and No. 6,199,920.

The U.S. Pat. No. 4,836,580 provides a hollow fitting body screwed in a terminal box and a general cylindrical form of connection device is located within the fitting body for use in securing an end of a corrugated pipe within the fitting body. The connection device has a plurality of finger portions, and the fitting body has a plurality of recesses corresponding to the finger portions respectively, therefore, each finger portion can be received within each of the recesses. Each of the finger portions adjacent to the corrugated pipe has a transverse cam surface protruding outwardly for engaging with the concave portion of the corrugated pipe. After the corrugated pipe inserting to the connection device, the cam surface can fix the corrugated pipe within the fitting body, therefore, the electrical wires can be passed to the terminal box through the corrugated pipe.

The U.S. Pat. No. 4,989,905 provides a retaining ring in a fitting body for securing a corrugated tube within the retaining ring. The structure of the U.S. Pat. No. 4,989,905 is similar to the above-mentioned U.S. Pat. No. 4,836,580, wherein the differences between them are that the retaining ring in U.S. Pat. No. 4,989,905 has several extending tabs, and each of the extending tabs has a detent member formed on the side adjacent to the corrugated tube for securing the corrugated tube after the tube is inserted into the retaining ring, so as to fix the corrugated tube with the fitting body.

The U.S. Pat. No. 6,199,920 provides an improved way for the corrugated tube capable of being loaded and unloaded repeatedly in accordance with the above-mentioned patents. The structure is similar to U.S. Pat. No. 4,835,580, which the finger portion adjacent to the corrugated tube has a transverse nose for securing the concave portion of the corrugated tube. A sloping surface is disposed in the fitting body and the finger portion opposing to each other. When the folder disposed in the fitting body is being moved by other tools, the corrugated tube can be unloaded and the extending detent member is separated from the corrugated tube based on the above-mentioned sloping surface to push the finger portion move outwardly.

Although above-mentioned three patents provide a pipeline structure capable of quick and convenient assembly, these three patents use the skill in the electrical pipeline to secure the corrugated tube by their transverse component, such as cam, detent member or nose, extending from a side adjacent to the corrugated tube of a finger portion or an extending tab, to secure the corrugated tube. However, when such structures are applied to the field of water pipe, it may emerge an issue of unreliable linkage.

Even though the U.S. Pat. No. 6,199,920 has mention that its structure can be applied in the water pipe, it may produce an issue of pressure change from the water hammer effect when a valve is suddenly closed. The changed water pressure may produce a strength to pull and drag the pipe, and sometimes this strength is sizable enough to damage the structure of the above-mentioned patents.

The components used for securing the corrugated tube in the above-mentioned patents, such as the finger portion or the extending tab, is only used its transverse component that adjacent to the corrugated tube, such as cam, detent member, or nose, to secure the corrugated tube. The strength ensured by such structure is quite limited, in particularly when changing the water pressure in a moment, it may cause the transverse component broken and make the problem of loosing the corrugated tube, and leads to the fact of water pipe leaking issues.

### SUMMARY OF THE INVENTION

The objective of the present invention is to solve the above-mentioned issues and to provide a quick installed joint assembly suitable for being quickly assembled and capable of ensuring the pipe linkage effect.

In order to achieve the above objects, the present invention provides a quick installed joint assembly, which includes: a fitting body, a cylindrical sleeve received within the fitting body, and an inlet pipe passed through the sleeve to be inserted within the fitting body. The fitting body has a chamber, in which one end of the chamber communicates with a water supply pipeline and the other end of the chamber communicates with an accommodation part and passes through the fitting body. The sleeve is slidingly disposed within the accommodation part and has a plurality of stopper portions spaced from one another in the sleeve. Each of the stopper portions has a wedge-like portion at an end far away from the sleeve, and a hook portion is extended outwardly from one side of the wedge-like portion. The fitting body has a plurality of openings corresponding to each of the stopper portions, in which each opening passes inwardly therethrough to the accommodation part, so that the hook portion of the stopper portion can be hooked on the upper surface of the openings. One end of the inlet pipe connects to a water outlet pipeline, and the other end of the inlet pipe passes through the sleeve and then is inserted within the chamber of the fitting body. The inlet pipe corresponding to the bottom of the stopper portion has a large diameter portion.

Therefore, when the inlet pipe of the present invention passes through the sleeve, the large diameter portion can force each of the stopper portions to expand. Therefore, each of the stopper portions can be slightly curved and deformed at each of the openings. After the large diameter portion passes through the sleeve, the stopper portion can be elastic recovery due to its flexible property and lean against on the large diameter portion, so as to fix the inlet pipe within the fitting body and reach the effect of quickly installation. Moreover, when there is water pressure, the large diameter portion of the inlet pipe is leaning against on the bottom edge of each stopper portion to push the stopper portion outward until the wedge-like portion reaching the inner wall of the expand portion, and then the stopper portion may move inward due to its flexible properties. Therefore, it can produce the effect of both the clipping and retaining to the large diameter portion of the inlet pipe, and make the inlet pipe being positioned reliably within the fitting body.

### BRIEF DESCRIPTION OF THE DRAWINGS

FIG. 1 is a schematic three dimensional view of the present invention;

FIG. 2 is a schematic diagram of the present invention;

FIG. 3 is an assembled sectional view of the present invention;

FIG. 4 is a first diagram to show the status of usage according to the present invention; and

FIG. 5 is a second diagram to show the status of usage according to the present invention.

### DETAILED DESCRIPTION OF THE INVENTION

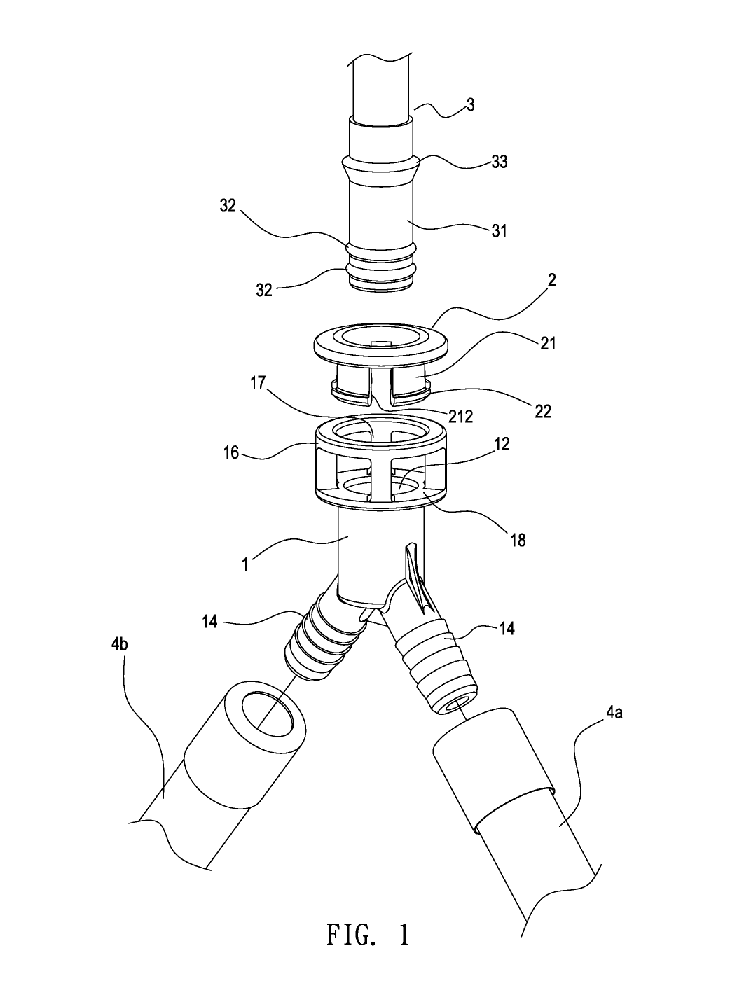

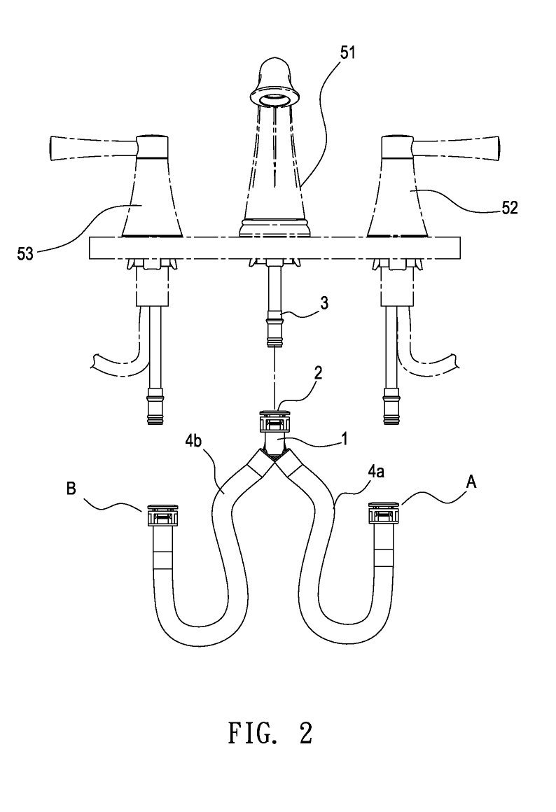

Refer to FIG. 1 and FIG. 2, which shows a preferred embodiment according to the invention. FIG. 1 is a schematic three dimensional view of the present invention and FIG. 2 is a schematic diagram of the present invention.

The quick installed joint assembly according to one embodiment of the invention includes a fitting body 1, an cylindrical sleeve 2 received within the fitting body 1, and an inlet pipe 3 passed through the sleeve 2 to be inserted within the fitting body 1.

The fitting body 1 according to one embodiment of the present invention has been designed to a three-way configuration. The fitting body 1 has a chamber 12 in use for the inlet pipe 3 to be inserted, and the fitting body 1 has two joints 14 extended from the fitting body 1. In addition, those two joints 14 have its pipeline communicating with the chamber 12, and these two joints 14 are used to receive the pipelines 4a, 4b.

This fitting body 1 has an expand portion 16 at the extending end of the chamber 12. The expand portion 16 has an accommodation part 17 for receiving the sleeve 2, in which the accommodation part 17 and the chamber 12 are communicated with each other.

A plurality of stopper portions 21 is disposed spaced from one another in the sleeve 2, in which each of the stopper portions 21 is extended a length axially from the sleeve 2. Each of the stopper portions 21 at an end away from the sleeve 2 has a hook portion 22 extending outwardly. The fitting body has a plurality of opening 18 corresponding to the stopper portions 21, respectively. Each of the openings 18 is in the structure configuration of radially inwardly passing therethrough until the accommodation part 17, such that each hook portion 22 of the stopper portion 21 can be positioned within the openings 18 in a hooking relation.

One end of the inlet pipe 3 connects to a faucet 51, and the other end has an insert portion 31. The insert portion 31 has two O-rings 32 in use to achieve the seal function after the insert portion 31 inserted within the chamber 12 of the fitting body 1. The inlet pipe 3 corresponding to the stopper portion 21 has a large diameter portion 33, so that it can result the effect of positioning by the stopper portion 21 being retaining with the large diameter portion 33, after the inlet pipe 3 is inserted within the fitting body 1.

Please refer to FIG. 2, it is a schematic diagram of the present invention. When the quickly installed joint assembly is applied in the practical operation, one end of the inlet pipe 3 connects to the faucet 51 and the fitting body 1 is designed in a configuration of the three-way pipe. Therefore, the two joints 14 of the fitting body 1 are used for receiving the pipelines 4a, 4b, and the other end of the pipelines 4a, 4b connects to the other group of quickly installed joint A, B, in order to connect to the cold water control value 52 and the hot water control value 53.

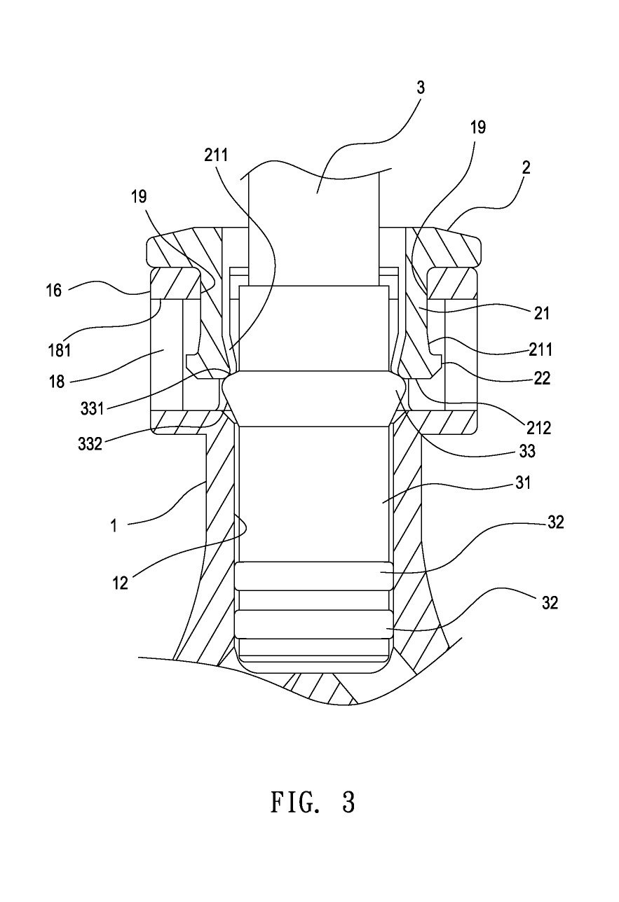

Please refer to FIG. 3, it is an assembled sectional view of the present invention. From the FIG. 3, each of the stopper portions 21 of the sleeve 2 forms a wedge-like portion 211 at an end far away from the sleeve 2, and afore-mentioned hook portion 22 is respectively formed by extending from one side of the wedge-like portion 211. An upper surface of each of the openings 18 forms a retaining surface 181 for retaining the hook portion 22 of the stopper portion 21, and an inside wall of the accommodation part 17 forms a supporting surface 19 for supporting the wedge-like portion 211 of each stopper portion 21.

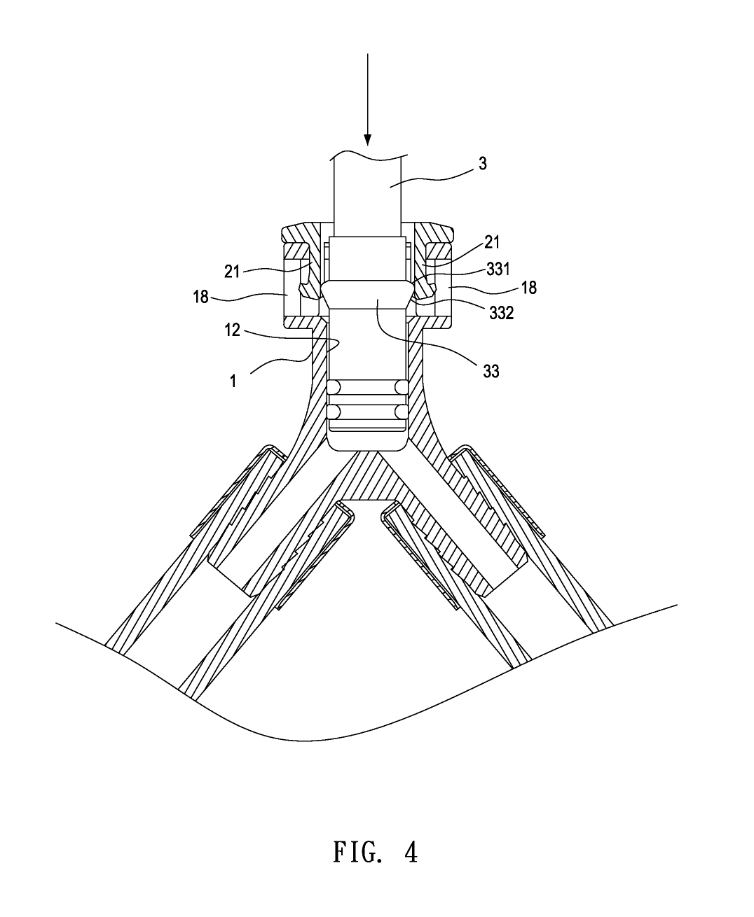

The large diameter portion 33 of the inlet pipe 3 has a upper surface 331 and a bottom surface 332, in which the upper surface 331 has a convex arc shape related to the radial of the inlet pipe 3 in use to lean against on the bottom edge 212 of he stopper portion 21, and the bottom surface 332 has a conical configuration related to the axis of the inlet pipe 3. When the inlet pipe 3 is inserted into the fitting body 1, the bottom surface 332 can prop up the stopper portion 21, as shown in FIG. 4, therefore, the large diameter portion 33 can pass through the sleeve 2.

When the present invention is used in practical operation, the inlet pipe 3 is firstly assembled underneath the bottom of the faucet 51, and then the faucet 51 is fixed to the washbasin. Next, the fitting body 1 disposed with a sleeve 2 is sleeved to the bottom of the inlet pipe 3 upwardly, so that the insert portion 31 of the inlet pipe 3 can be inserted through the cylindrical sleeve 2 and received in the chamber 12 of the fitting body 1. The bottom surface 332 of the large diameter portion 33 can prop up the stopper portions 21, as shown in FIG. 4, so that each of the stopper portions 21 are slightly curved outwardly at each of the openings 18. After the large diameter portion 33 passes through the sleeve 2, the stopper portion 21 will be elastic recovery due to its flexible property, and then lean against on the upper surface 331 of the large diameter portion 33, so as to combine the inlet pipe 3 and the fitting body 1, as shown in FIG. 3.

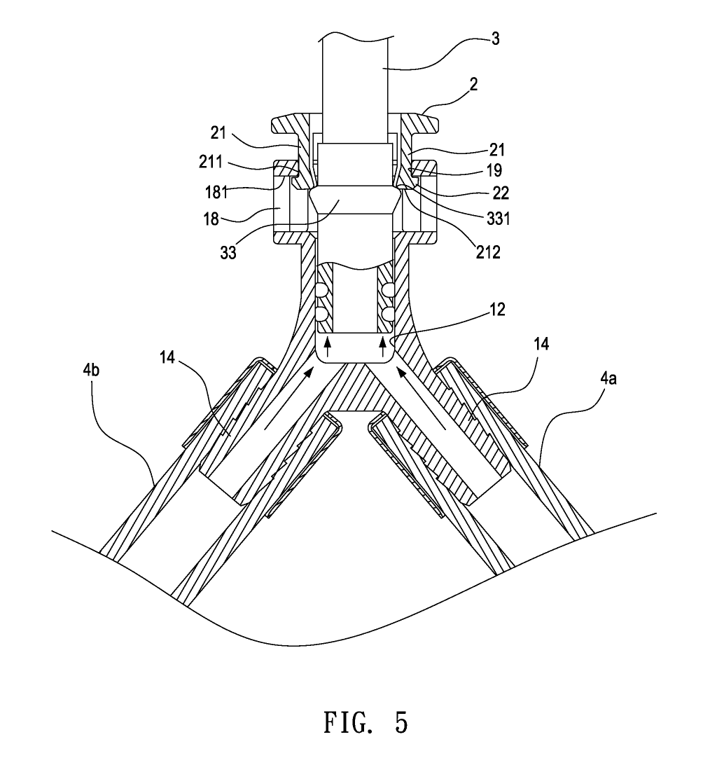

Please refer to FIG. 5, it is a second diagram to show the status of usage according to the present invention. After all the components have been connected properly, the water flow can move in the direction from the pipelines 4a and/or 4b passing through the joints 14 to the chamber 12 of the fitting body 1 when the water value is turned on. Due to the effect of the water pressure, the inlet pipe 3 will be push outwardly by the water pressure until the hook portion 22 of the stopper portion 21 is retained by the retaining surface 181 of the opening 18.

During the process, the upper surface 331 of the large diameter portion 33 is leaning against on the bottom edge 212 of the stopper portion 21, so as to push the stopper portion 21 moving outwardly, as shown at the top of FIG. 5. Due to the end of the stopper portion 21 far away from the sleeve 2 being a wedge-like portion 211, the wedge-like portion 211 of the stopper portion 21 moves inward accordingly after the sleeve 2 is moved until the wedge-like portion 221 reaching the supporting surface 19 of the inside wall of the expand portion 16, so as to produce the effect of both the clipping and retaining, and make the inlet pipe being positioned within the fitting body 1 reliably.

Moreover, the stopper portion 21 is retained by the upper surface 331 of the large diameter portion 33 of the inlet pipe 3 based on its bottom edge 212, and the wedge-like portion 211 of the stopper portion 21 can be effected to move inwardly by the supporting surface 19. Therefore, each of the stopper portion 21 adopt its whole structure to resist the effect of the water pressure, which is not the same as the one disclosed by the protruding elements of the prior art. Hence, the stopper portion 21 of the present invention can results the pipeline combination effectively and reliably.

Though the present invention has been disclosed above by the preferred embodiments, they are not intended to limit the present invention. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A quick installed joint assembly, comprising:
a fitting body having a chamber and an accommodation part extending from the chamber, one end of the chamber communicating with a water supply pipeline and the other end of the chamber communicating with the accommodation part;
a sleeve, slidingly disposed within the accommodation part of the fitting body, having a plurality of stopper portions spaced from one another in the sleeve, each of the stopper portions having a wedge-like portion at one end far away from the sleeve, and a hook portion extending from one side of the wedge-like portion, wherein a plurality of openings is formed in the fitting body at locations corresponding to each of the stopper portions such that each opening passes inwardly therethrough to the accommodation part in use for hooking the hook portion in a upper surface of the opening; and
an inlet pipe, one end of the inlet pipe connecting to a water outlet pipeline, and the other end of the inlet pipe passing through the sleeve and being inserted within the chamber of the fitting body, the inlet pipe having a large diameter portion formed on the exterior surface at a location corresponding to a bottom edge of the stopper portions,
wherein the large diameter portion of the inlet pipe has an upper surface and a bottom surface, the upper surface is smooth convex arc-shaped as so to lean against on the bottom edge of the stopper portions in use, and the bottom surface is conical-shaped, and wherein the inlet pipe is detachable from the sleeve;
wherein the other end of the inlet pipe has an insert portion, the insert portion having two O-rings to seal insertion between the insert portion and the chamber of the fitting body;
wherein the fitting body at the end having the accommodation part forms an expand portion;
wherein an upper surface of each of the openings of the fitting body forms a retaining surface for the hook portion of the stopper portion of the sleeve to be retained thereon; and wherein an inside wall of the accommodation part of the fitting body forms a supporting surface for the wedge-like portions of the stopper portion of the sleeve to be supported thereon.

2-6. (canceled)
